(19) United States
(12) Patent Application Publication
(10) Pub. No.: US 2016/0356287 A1
(43) Pub. Date: Dec. 8, 2016

(54) ASYMMETRIC VANE FAN AND METHOD

(71) Applicant: Twin City Fan Companies, Ltd., Plymouth, MN (US)

(72) Inventors: Daniel Khalitov, St. Louis Park, MN (US); Radha Krishna Ganesh, Rogers, MN (US); Chi Tang, Maple Grove, MN (US)

(21) Appl. No.: 15/172,455

(22) Filed: Jun. 3, 2016

Related U.S. Application Data
(60) Provisional application No. 62/170,437, filed on Jun. 3, 2015.

(51) Int. Cl. F04D 29/54; F04D 29/66; F04D 25/08; F04D 29/32

(52) U.S. Cl. CPC F04D 29/541; F04D 29/325; F04D 29/666; F04D 25/082; F05B 2240/12; F05B 2260/96; F05B 2260/20

(57) ABSTRACT

A fan assembly is shown. Examples of fan assemblies shown include asymmetric vanes. In one example, the vanes are substantially identical, but are located asymmetrically with respect to one another. In one example the vanes are asymmetric with respect to one another. In one example, the vanes are both asymmetrically located and are asymmetric with respect to one another. Fan assemblies and vanes are further shown that include hollow vanes. Passages in the hollow vanes may allow external air to contact a fan motor and/or mix with a primary flow.

### CLAIM OF PRIORITY

This application claims the benefit of priority to U.S. Provisional Application, Ser. No. 62/170,437, filed on Jun. 3, 2015, which is hereby incorporated by reference herein in its entirety.

### TECHNICAL FIELD

Embodiments described herein generally relate to fans. In selected examples, the present application relates more specifically to asymmetric vanes in a fan assembly.

### BACKGROUND

Fans may be used for a number of end uses, including, but not limited to a general ventilation fan, a process fan, a central or jet fan for metro and tunnel ventilation, a mancooler, a drying jet fan, a wind tunnel fan, or similar applications. It is desirable to provide fans that are effective and inexpensive to manufacture. It is also desirable to provide fans that operate with low noise.

Examples of fan assemblies are described that address these, and other desires.

### BRIEF DESCRIPTION OF THE DRAWINGS

FIG. 1 shows an isometric view of a fan assembly according to an example of the invention.

FIG. 2 shows an exploded view of a fan assembly according to an example of the invention.

FIG. 3A shows a side view of a fan assembly according to an example of the invention.

FIG. 3B shows a cross section view of a fan assembly according to an example of the invention.

FIG. 4 shows an isometric cross section view of a fan assembly according to an example of the invention.

FIG. 5A shows a top view of a portion of a fan assembly according to an example of the invention.

FIG. 5B shows a side view of a vane according to an example of the invention.

FIG. 5C shows an end view of a vane according to an example of the invention.

### DESCRIPTION OF EMBODIMENTS

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

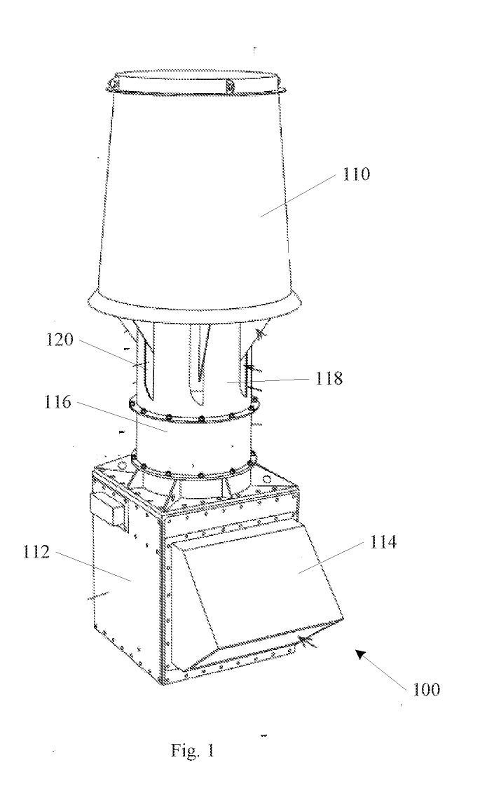

FIG. 1 shows a fan assembly 100. The fan assembly includes an inlet 114 coupled to a chamber 112. In impeller housing 116 is coupled to the chamber 112, and a flow housing 118 is coupled to the impeller housing 116. A number of vanes 120 are located within the flow housing 118, and will be described in more detail below. In the example of FIG. 1, a windband 110 is further coupled above the flow housing 118, although the invention is not so limited. Other example fan assemblies may not include a windband 110. In one example, the windband 110 is coupled to portions of the vanes 120, which suspend the windband 110 in position over the flow housing 118.

In one example, the vanes 120 are asymmetric. As will be described in more detail below, asymmetric vanes 120 provide a number of advantages, including, but not limited to noise reduction as a result of reducing harmonics in the fan assembly. In one example, the asymmetric vanes include substantially identical vanes that are asymmetrically located with respect to one another. In one example, the asymmetric vanes include vanes with different geometries that are symmetrically located with respect to one another. In one example, the asymmetric vanes include vanes with different geometries that are asymmetrically located with respect to one another. In other words, the asymmetry may be in vane geometry, vane location or both vane geometry and vane location.

In one example, the vanes 120 are hollow vanes, although the invention is not so limited. Further, in one example the vanes 120 are open on one end to allow external air to mix with the air flow within the flow housing 118. Examples of hollow vanes 120, and vanes 120 that are open on one end will be described in more detail below.

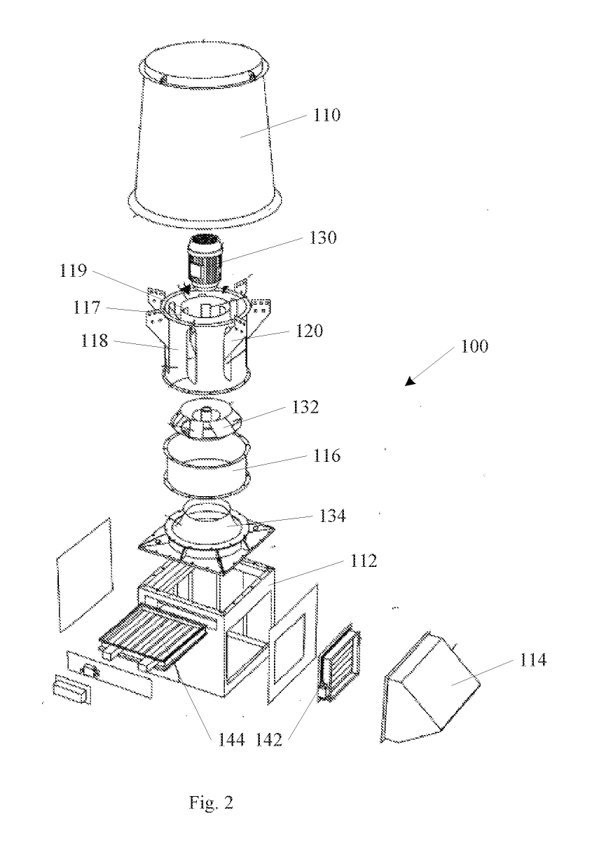

FIG. 2 shows an exploded view of the fan assembly 100 from FIG. 1. The fan assembly 100 includes an inlet cone 134 coupled to a side of the chamber 112 and to the impeller housing 116. A first baffle 142 and a second baffle 144 are optionally included to selectively control air flow from the inlet 114 to the chamber 112, and from the chamber 112 to the inlet cone 134.

An impeller 132 is shown that is coupled to a motor 130. In the example shown, the motor 130 is housed within an interior space of the flow housing 118. FIG. 2 shows a motor housing 119 that is located within the flow housing 118, and defining a flow space 117 located between the flow housing 118 and the motor housing 119. FIG. 2 further shows the number of vanes 120 located within the flow space 117, and bridging between an inner diameter of the flow housing 118 to an outer diameter of the motor housing 119.

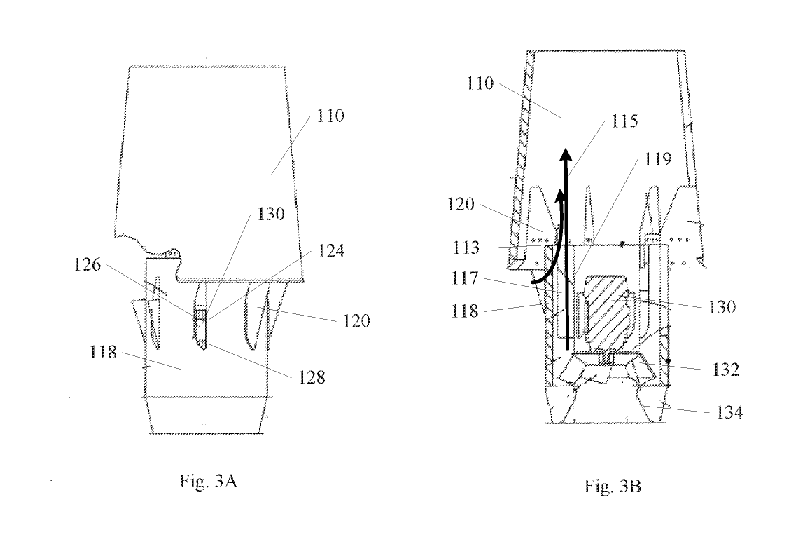

FIG. 3A shows A side view of the fan assembly 100. The vanes 120 are shown spaced about the flow housing 118. A first vane side 124, a second vane side 126, and a vane tip 128 define a hollow space within the vane 120 that allows external air to enter the flow space 117 and/or the motor housing 119. In FIG. 3A, a portion of the motor 130 can be seen through one of the hollow vanes 120.

FIG. 3B shows a cross section of the fan assembly 100 in the orientation depicted in FIG. 3A. The motor 130 is shown housed within the motor housing 119. A primary flow direction is indicated by arrow 115. In operation, the impeller 132 moves air through the inlet cone 134 and into the flow space 117. Air within the flow space is directed over the vanes 120, which may straighten a flow path of, or otherwise direct, the outgoing air. In the example of FIG. 3B, the vanes 120 include hollow vanes, having an open top end. a secondary flow direction is indicated by arrow 113, which may include external air that mixes with the primary flow 115. In addition to mixing with the primary flow 115, in one example, external air may pass through the hollow vane 120 and into the motor housing 119. Such a configuration may have an additional benefit of providing an amount of motor cooling.

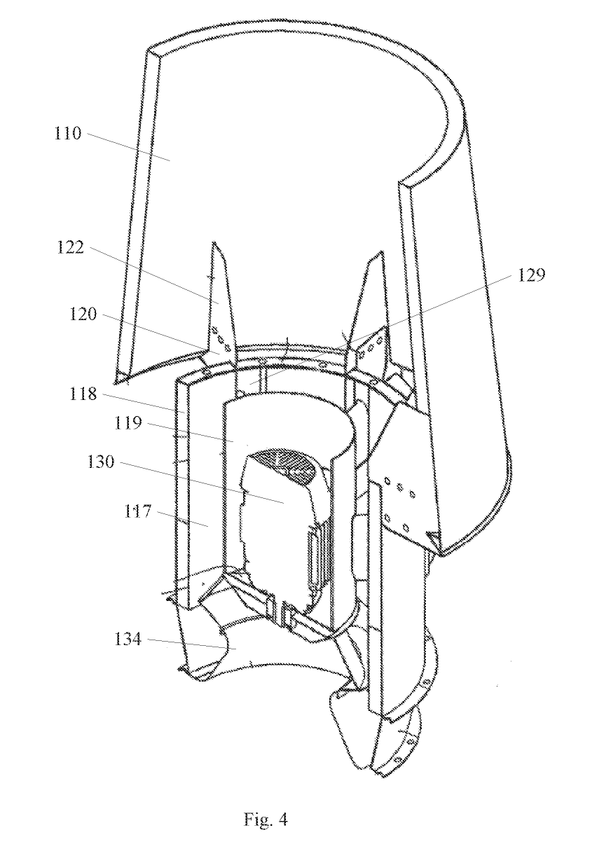

FIG. 4 illustrates yet another view of the fan assembly 100 in cross section. The flow space 117 is shown between the motor housing 119 and the flow housing 118. Space 129 within a hollow van 120 is shown indicating where external air may pass through the flow housing 118 and enter the primary flow within the flow space 117.

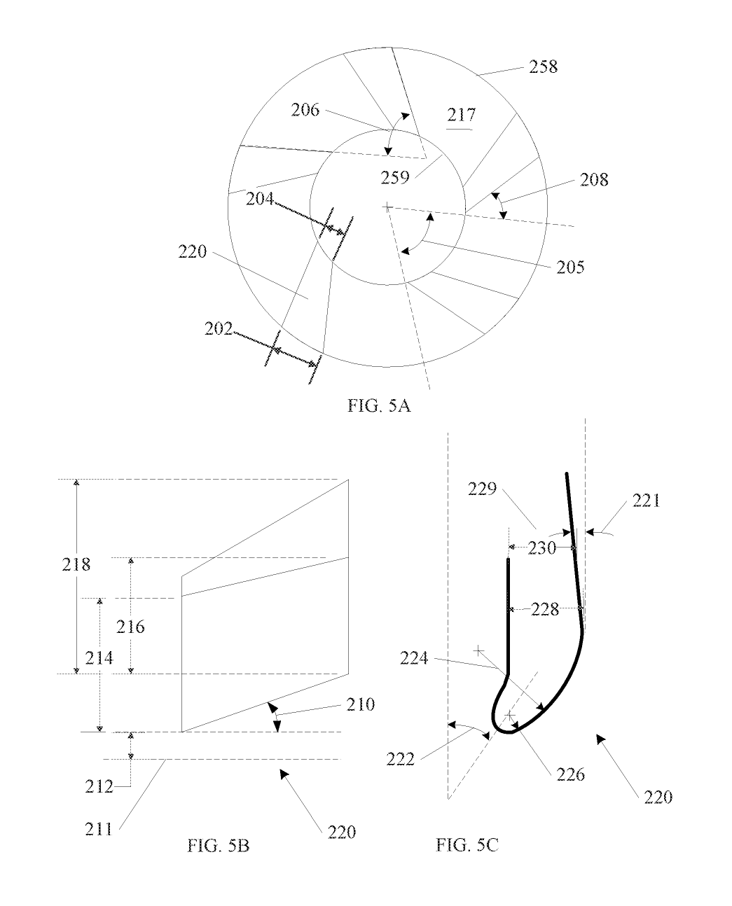

As mentioned above, the vanes 120 may include asymmetric vanes. FIGS. 5A-5C illustrate a number of vane dimensions that may be varied to provide asymmetric vanes within the fan assembly 100.

FIG. 5A shows a number of vanes 220, similar to previously described vanes 120, spaced within a flow space 217. In the example shown, the flow space 217 is defined between a motor housing 259 and a flow housing 258. As discussed above, in one example, the vanes 220 are asymmetric vanes, which may provide advantages such as reduced fan noise.

In one example of asymmetric vanes, an angle 205 between vanes 220 is asymmetric. In one example of asymmetric vanes, a sweep angle 208 from one vane to another is asymmetric. In one example of asymmetric vanes, an angle between leading edge centerlines 206 from one vane to another is asymmetric. In one example of asymmetric vanes, an inner vane thickness 204 from one vane to another is asymmetric. In one example of asymmetric vanes, an outer vane thickness 202 from one vane to another is asymmetric.

FIG. 5B shows other examples of vane dimensions that may be varied to provide asymmetric vanes. In one example, a vane offset height 212 from a motor plane line 211 is varied from one vane to another. In one example, a first vane length 214 is varied from one vane to another. In one example, a second vane length 216 is varied from one vane to another. In one example, a third vane length 218 is varied from one vane to another. In one example, a vane yaw angle 210 is varied from one vane to another.

FIG. 5C shows other examples of vane dimensions that may be varied to provide asymmetric vanes. In one example, a trailing edge angle 221 is varied from one vane to another. In one example, a leading edge angle 222 is varied from one vane to another. In one example, a camber line radius 224 is varied from one vane to another. In one example, a leading edge curvature radius 226 is varied from one vane to another. In one example, a vane thickness 228 at a vane midsection is varied from one vane to another. In one example, a vane thickness 230 at vane length 216 is varied from one vane to another.

Although variation in individual dimensions and angles are described above to illustrate examples of asymmetric vanes, the invention is not so limited. For example, variations of two or more variables such as the examples described above may provide asymmetric vanes. In addition, the above list of variables is not intended to be exhaustive. One of ordinary skill in the art, having the benefit of the present disclosure, will recognize that variations in other vane dimensions, angles, etc. may also provide asymmetric vanes.

To better illustrate the method and apparatuses disclosed herein, a non-limiting list of embodiments is provided here:

Example 1 includes a fan assembly. The fan assembly includes a flow space defined between an outer housing and an inner housing, a fan motor located within the inner housing, an impeller coupled to the fan motor to drive a fluid through the flow space, and a number of asymmetric vanes located within the flow space to direct a fluid flow through the flow space.

Example 2 includes the fan assembly of example 1 wherein the number of asymmetric vanes includes a number of substantially identical vanes that are asymmetrically spaced angularly about a central axis.

Example 3 includes the fan assembly of any one of examples 1-2, wherein the number of asymmetric vanes includes a number of vanes that are asymmetrical with respect to one another.

Example 4 includes the fan assembly of any one of examples 1-3, wherein the number of asymmetric vanes includes a number of vanes that are asymmetrical with respect to one another that are also asymmetrically spaced angularly about a central axis.

Example 5 includes the fan assembly of any one of examples 1-4, wherein the fan assembly is incorporated into a ventilation system.

Example 6 includes the fan assembly of any one of examples 1-5, wherein the number of vanes that are asymmetrical with respect to one another includes a different yaw angle between vanes.

Example 7 includes the fan assembly of any one of examples 1-6, wherein the number of vanes that are asymmetrical with respect to one another includes a different vane thickness between vanes.

Example 8 includes the fan assembly of any one of examples 1-7, wherein the number of vanes that are asymmetrical with respect to one another includes a pitch angle that is different between vanes.

Example 9 includes the fan assembly of any one of examples 1-8, wherein the number of vanes that are asymmetrical with respect to one another includes a sweep angle that is different between vanes.

Example 10 includes the fan assembly of any one of examples 1-9, wherein the number of vanes that are asymmetrical with respect to one another includes a vane length that is different between vanes.

Example 11 includes the fan assembly of any one of examples 1-10, wherein the number of vanes that are asymmetrical with respect to one another includes vane offset along a flow direction that is different between vanes.

Example 12 includes a fan assembly. The fan assembly includes a flow space defined between an outer housing and an inner housing, a fan motor located within the inner housing, an impeller coupled to the fan motor to drive a fluid through the flow space, and a number of asymmetric hollow vanes located within the flow space to direct a fluid flow through the flow space, wherein the hollow vanes provide an air pathway for external air to reach the fan motor.

Example 13 includes the fan assembly of example 12, wherein the number of asymmetric vanes includes a number of substantially identical vanes that are asymmetrically spaced angularly about a central axis.

Example 14 includes the fan assembly of any one of examples 12-13, wherein the number of asymmetric vanes includes a number of vanes that are asymmetrical with respect to one another.

Example 15 includes the fan assembly of any one of examples 12-14, wherein the number of asymmetric vanes includes a number of vanes that are asymmetrical with respect to one another that are also asymmetrically spaced angularly about a central axis.

Example 16 includes a fan assembly. The fan assembly includes a flow space defined between an outer housing and an inner housing, a fan motor located within the inner housing, an impeller coupled to the fan motor to drive a fluid through the flow space, and a number of asymmetric hollow vanes located within the flow space to direct a fluid flow through the flow space, wherein the hollow vanes include a trailing edge opening to allow external air to mix with a primary flow.

Example 17 includes the fan assembly of example 16, wherein the hollow vanes further include an opening to provide an air pathway for external air to reach the fan motor.

Example 18 includes the fan assembly of any one of examples 16-17, wherein the number of asymmetric vanes includes a number of substantially identical vanes that are asymmetrically spaced angularly about a central axis.

Example 19 includes the fan assembly of any one of examples 16-18, wherein the number of asymmetric vanes includes a number of vanes that are asymmetrical with respect to one another.

Example 20 includes the fan assembly of any one of examples 16-19, wherein the number of asymmetric vanes includes a number of vanes that are asymmetrical with respect to one another that are also asymmetrically spaced angularly about a central axis.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A fan assembly, comprising:
a flow space defined between an outer housing and an inner housing;
a fan motor located within the inner housing;
an impeller coupled to the fan motor to drive a fluid through the flow space;
a number of asymmetric vanes located within the flow space to direct a fluid flow through the flow space.

2. The fan assembly of claim 1, wherein the number of asymmetric vanes includes a number of substantially identical vanes that are asymmetrically spaced angularly about a central axis.

3. The fan assembly of claim 1, wherein the number of asymmetric vanes includes a number of vanes that are asymmetrical with respect to one another.

4. The fan assembly of claim 1, wherein the number of asymmetric vanes includes a number of vanes that are asymmetrical with respect to one another that are also asymmetrically spaced angularly about a central axis.

5. The fan assembly of claim 1, wherein the fan assembly is incorporated into a ventilation system.

6. The fan assembly of claim 3, wherein the number of vanes that are asymmetrical with respect to one another includes a different yaw angle between vanes.

7. The fan assembly of claim 3, wherein the number of vanes that are asymmetrical with respect to one another includes a different vane thickness between vanes.

8. The fan assembly of claim 3, wherein the number of vanes that are asymmetrical with respect to one another includes a pitch angle that is different between vanes.

9. The fan assembly of claim 3, wherein the number of vanes that are asymmetrical with respect to one another includes a sweep angle that is different between vanes.

10. The fan assembly of claim 3, wherein the number of vanes that are asymmetrical with respect to one another includes a vane length that is different between vanes.

11. The fan assembly of claim 3, wherein the number of vanes that are asymmetrical with respect to one another includes vane offset along a flow direction that is different between vanes.

12. A fan assembly, comprising:
a flow space defined between an outer housing and an inner housing;
a fan motor located within the inner housing;
an impeller coupled to the fan motor to drive a fluid through the flow space;
a number of asymmetric hollow vanes located within the flow space to direct a fluid flow through the flow space, wherein the hollow vanes provide an air pathway for external air to reach the fan motor.

13. The fan assembly of claim 12, wherein the number of asymmetric vanes includes a number of substantially identical vanes that are asymmetrically spaced angularly about a central axis.

14. The fan assembly of claim 12, wherein the number of asymmetric vanes includes a number of vanes that are asymmetrical with respect to one another.

15. The fan assembly of claim 12, wherein the number of asymmetric vanes includes a number of vanes that are asymmetrical with respect to one another that are also asymmetrically spaced angularly about a central axis.

16. A fan assembly, comprising:
a flow space defined between an outer housing and an inner housing;
a fan motor located within the inner housing;
an impeller coupled to the fan motor to drive a fluid through the flow space;
a number of asymmetric hollow vanes located within the flow space to direct a fluid flow through the flow space, wherein the hollow vanes include a trailing edge opening to allow external air to mix with a primary flow.

17. The fan assembly of claim 16, wherein the hollow vanes further include an opening to provide an air pathway for external air to reach the fan motor.

18. The fan assembly of claim 16, wherein the number of asymmetric vanes includes a number of substantially identical vanes that are asymmetrically spaced angularly about a central axis.

19. The fan assembly of claim 16, wherein the number of asymmetric vanes includes a number of vanes that are asymmetrical with respect to one another.

20. The fan assembly of claim 16, wherein the number of asymmetric vanes includes a number of vanes that are asymmetrical with respect to one another that are also asymmetrically spaced angularly about a central axis.
